(19) United States
(12) Patent Application Publication
(10) Pub. No.: US 2012/0210558 A1
(43) Pub. Date: Aug. 23, 2012

(54) UPSET PROTRUSION JOINING

(76) Inventors: Stephen D. Logan, Northville, MI (US); David M. Langer, Warren, MI (US)

(21) Appl. No.: 13/031,713

(22) Filed: Feb. 22, 2011

(51) Int. Cl. F16B 17/00; B23P 11/00

(52) U.S. Cl. 29/527.5; 403/280

(57) ABSTRACT

A method of coupling a plurality of parts together includes casting a first part to include a base and a protrusion that protrudes from the base. The first part is made from a metallic material. The method also includes providing a second part with an opening and mating the first and second parts such that the protrusion is received within the opening. Moreover, the method includes deforming the protrusion over the second part such that the second part is retained between the deformed protrusion and the base of the first part.

### FIELD

The present invention relates to joining a plurality of parts and, more particularly, relates to upset protrusion joining of a plurality of parts.

### BACKGROUND

Fasteners, such as bolts, nuts, screws, etc. are often used to join different parts together. However, assembling parts in this manner can be labor intensive and costly. Also, the fasteners can promote galvanic corrosion if one of the parts being joined is made from a different material than the fastener. There are several factors that are considered when deciding which of these joining methods to use, such as the material used to make the parts, the geometry of the parts, integrity and strength of the joint, deflection characteristics under manufacturing and in-use conditions, etc.

The following relates to a method of joining a plurality of parts together in a robust manner. The method also allows parts made of different materials to be joined together. Moreover, the method allows parts to be joined at high-volume production rates.

### SUMMARY

A method of coupling a plurality of parts together is disclosed. The method includes casting a first part to include a base and a protrusion that protrudes from the base. The first part is made from a metallic material. The method also includes providing a second part with an opening and mating the first and second parts such that the protrusion is received within the opening. Moreover, the method includes deforming the protrusion over the second part such that the second part is retained between the deformed protrusion and the base of the first part.

Also, an assembly is disclosed that includes a first part that is made from cast metallic material. The first part includes a base and a protrusion. The assembly also includes a second part with an opening that receives the protrusion. The protrusion is deformed such that the second part is retained between the deformed protrusion and the base of the first part.

Further area of applicability of the present disclosure will become apparent from the detailed description and claims provided hereinafter. It should be understood that the detailed description, including disclosed embodiments and drawings, are merely exemplary in nature intended for purposes of illustration only and are not intended to limit the scope of the invention, its application or use. Thus, variations that do not depart from the gist of the invention are intended to be within the scope of the invention.

### BRIEF DESCRIPTION OF THE DRAWINGS

FIG. 1 is a perspective view of a plurality of parts to be coupled according to teachings of the present disclosure;

FIG. 2 is a sectional view of one of the parts of FIG. 1 being cast;

FIG. 3 is a perspective view of the plurality of parts of FIG. 1 mated together;

FIG. 4 is a perspective view of a tool used to join the plurality of parts of FIG. 1;

FIG. 5 is a sectional view of the tool used to join the plurality of parts of FIG. 1;

FIG. 6 is a sectional view showing the tool of FIGS. 4 and 5 deforming a protrusion of one of the parts of FIG. 1;

FIG. 7 is a perspective view of the plurality of parts of FIG. 1 coupled together;

FIG. 8 is a perspective view of a plurality of parts to be coupled together according to additional exemplary embodiments of the present disclosure;

FIG. 9 is a perspective view of a tool used to join the plurality of parts of FIG. 8;

FIG. 10 is a perspective view of the tool of FIG. 9 deforming a protrusion of one of the parts of FIG. 8;

FIG. 11 is a perspective view of the plurality of parts of FIG. 8 coupled together;

FIG. 12 is a perspective view of a plurality of parts to be coupled together according to additional exemplary embodiments of the present disclosure; and

FIG. 13 is a perspective view of the plurality of parts of FIG. 12 shown coupled.

### DETAILED DESCRIPTION

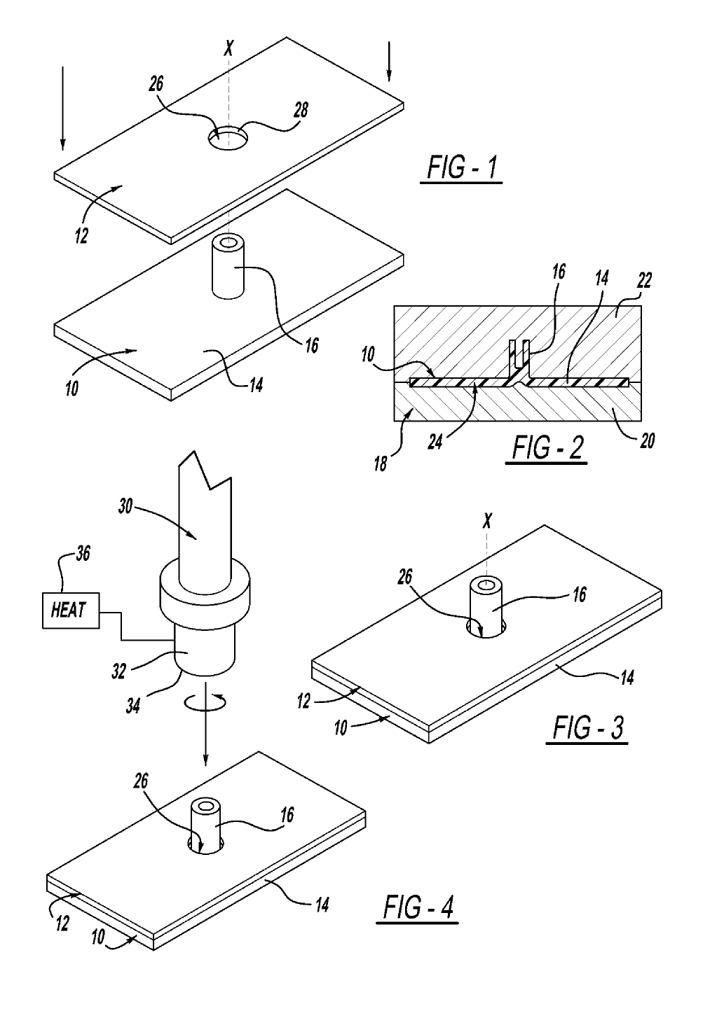

Referring initially to FIG. 1, a first part 10 and a second part 12 are shown according to various exemplary embodiments of the present disclosure. The first and second parts 10, 12 can have any suitable shape, can be made out of any suitable material, and can vary in other ways. The first and second parts 10, 12 can be coupled (e.g., fixed) together as will be discussed in greater detail.

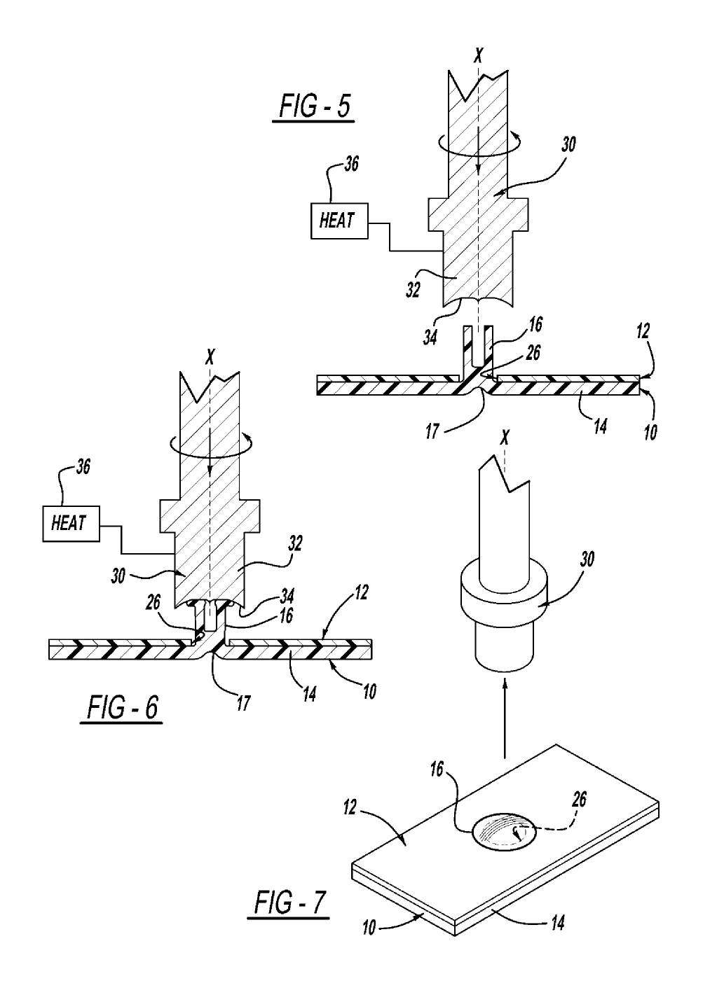

The first part 10 can include a base 14 and a protrusion 16. The base 14 can be sheet-like as shown, or the base 14 can have any other shape, such as a block shape, a shape with more complex surface features (e.g., grooves, curved surfaces, plural flat surfaces, holes or other apertures, etc.). The protrusion 16 can be substantially cylindrical as shown, or the protrusion 16 can have any other shape. Also, in the embodiments illustrated, the protrusion 16 is hollow and open at an end opposite the base 14; however, the protrusion 16 can have a solid cross section in other embodiments. The first part 10 can also include a dimple-shaped recess 17 (FIG. 5) underneath the protrusion 16 as well.

In the embodiment shown, the protrusion 16 has a substantially straight axis X that extends substantially perpendicular to the base 14; however, the protrusion 16 can have a non-linear axis X, and the axis X can extend away from the base 14 at any angle. Also, in the embodiment shown, the protrusion 16 has a substantially circular cross sectional shape taken perpendicular to the axis X; however, the protrusion 16 can have any cross sectional shape, such as an ovate shape, a polygonal shape, or otherwise. Moreover, the protrusion 16 can have any suitable length and width. Also, the protrusion 16 can be integrally attached at one end to the base 14 such that the base 14 and protrusion 16 are monolithic.

The first part 10 can be formed via a metal casting process as shown in FIG. 2. Specifically, a mold 18 with a first portion 20 and a second portion 22 is provided. A cavity 24 is defined between the first and second portions 20, 22. Molten metallic material is introduced into the cavity 24, and upon cooling, the first part 10 is formed, and then the first and second portions 20, 22 of the mold 18 are removed. It will be appreciated that the protrusion 16 can be hollow and the wall thicknesses of the first part 10 can be substantially constant, or the first part 10 and protrusion 16 can have varying wall thicknesses. It will also be appreciated that the mold 18 can include inserts for defining cavities within the first part 10 or any other components for forming the first part 10 into any suitable shape. Accordingly, the first part 10 can be formed efficiently at high-volume production rates.

The first part 10 can be made out of any suitable material. For instance, in some embodiments, the first part 10 can be made out of magnesium or magnesium alloy. As such, the first part 10 can be relatively lightweight, inexpensive, and able to be casted in the mold 18. In other embodiments, the first part 10 is made out of aluminum, aluminum alloy, or other cast material.

Referring back to FIG. 1, the second part 12 will be discussed in greater detail. The second part 12 can have any suitable shape, such as the substantially flat, sheet-like shape illustrated. In other embodiments, the second part 12 can have a block-like shape and can include curved and/or flat surfaces, etc.

The second part 12 can include an opening 26 defined therein. In the embodiments shown, the opening 26 can be a through-hole with an inner surface 28 that extends therethrough. In other embodiments, the opening 26 can be a groove, a notch, a pocket, an undercut or any other type. The opening 26 can have any suitable shape, and in some embodiments, the shape of the opening 26 can correspond to that of the protrusion 16. Specifically, the opening 26 can have a similar shape as the protrusion 16 and can be sized to receive the protrusion 16.

The second part 12 can be made out of any suitable material (metal, polymer, or ceramic). In some embodiments, the second part 12 is made out of a material that is different or dissimilar from the material of the first part 10. For instance, if the first part 10 is made out of magnesium or magnesium alloy, the second part 12 can be made out of aluminum or aluminum alloy. In other embodiments, the first and second parts 10, 12 are made out of similar or related materials.

Also, the second part 12 can be formed in any suitable manner. In some embodiments, the second part 12 is cast, similar to methods of forming the first part 10 described above and illustrated in FIG. 2. In other embodiments, the second part 12 is stamped, extruded, or otherwise formed. Also, the opening 26 can be formed through the molding process, by a cutting tool (e.g., drill bit, etc.), or through any suitable process.

Referring now to FIGS. 3-7, the method of coupling the first and second parts 10, 12 together will be discussed in greater detail. The first and second parts 10, 12 can be mated together such that the protrusion 16 is received within the opening 26 and such that the second part 12 lies over and abuts the base 14 of the first part 10.

A tool 30 is used to deform the protrusion 16 over the second part 12 such that the second part 12 is retained between the deformed protrusion 16 and the base 14 of the first part 10. Specifically, the tool 30 can be aligned with the protrusion 16 and can be moved along or parallel to the axis X to exert a force (i.e., press) on the protrusion 16 along the axis X to thereby deform the protrusion 16 radially outward away from the axis X. As shown in FIG. 7, the tool 30 can deform the protrusion 16 radially outward from the axis X until the width of the deformed protrusion 16 exceeds the width of the opening 26. Also, the protrusion 16 can be deformed enough to substantially fill the opening 26 and to fixedly couple the second part 12 to the base 14 and/or deform the second part 12 against the base 14. In other embodiments, the protrusion 16 can be deformed only partially, such that the second part 12 remains moveably coupled to the first part 10.

The tool 30 can be elongate with a head 32 having a recess 34 defined therein. The recess 34 can be concave and curved. The recess 34 can be shaped according to the protrusion 16. For instance, the recess 34 can be large enough to receive the protrusion 16 and can be curved so as to shape the protrusion 16 as the protrusion 16 is deformed. In the embodiments shown in FIG. 7, the deformed protrusion 16 is convexly curved and disc-shaped due to the shape of the recess 34. However, it will be appreciated that the tool 30 can have any shape for deforming the protrusion 16 into any desired shape.

As stated above, the tool 30 can apply axial pressure to deform the protrusion 16. However, it will be appreciated that the tool 30 can deform the protrusion 16 in any suitable manner. For instance, in addition to or instead of applying pressure, the tool 30 can apply friction and/or heat to deform the protrusion 16. In some embodiments (e.g., the embodiments illustrated in FIG. 4), the tool 30 can rotate about the axis X as the tool 30 moves axially to create friction between the tool 30 and the protrusion 16. Also, a heating element 36 can be operably connected to the tool 30 to increase the temperature of the head 32. This heat can transfer to the protrusion 16 and facilitate deformation of the protrusion 16.

Thus, the first and second parts 10, 12 can be formed and assembled together in a highly efficient manner in a high-volume production environment. A plurality of first parts 10 can be cast and stocked and then subsequently joined to respective second parts 12 when desired. Also, the parts 10, 12 can be made out of dissimilar materials (e.g., magnesium and aluminum or alloys thereof), and galvanic corrosion can be less problematic than in other assemblies (e.g., where steel fasteners are used for joining parts). Also, when the parts 10, 12 are joined, the resulting assembly can have a very low weight and, yet, can have substantial strength and rigidity. For instance, an aluminum second part 12 can provide strength and rigidity while a magnesium first part 10 can provide significant weight savings.

It will be appreciated that the first and second parts 10, 12 can form any suitable assembly. For instance, the first and second parts 10, 12 can be joined to form a vehicle part assembly, such as a vehicle door assembly, a part of a vehicle chassis assembly, an engine part, and the like.

Other variations from the embodiments described above are also within the scope of the present disclosure. For instance, an adhesive (not shown) can be additionally provided between the first and second parts 10, 12, and the adhesive can reinforce the coupling the deformed protrusion 16 provides. Moreover, in some embodiments at least one of the first and second parts 10, 12 can be coated with a material that reduces corrosion. The coating can occur before or after the first and second parts 10, 12 are joined together. Also, surfaces of the first or second part 10, 12 that abut the surfaces of the other can be coated such that there is even less likelihood of galvanic corrosion.

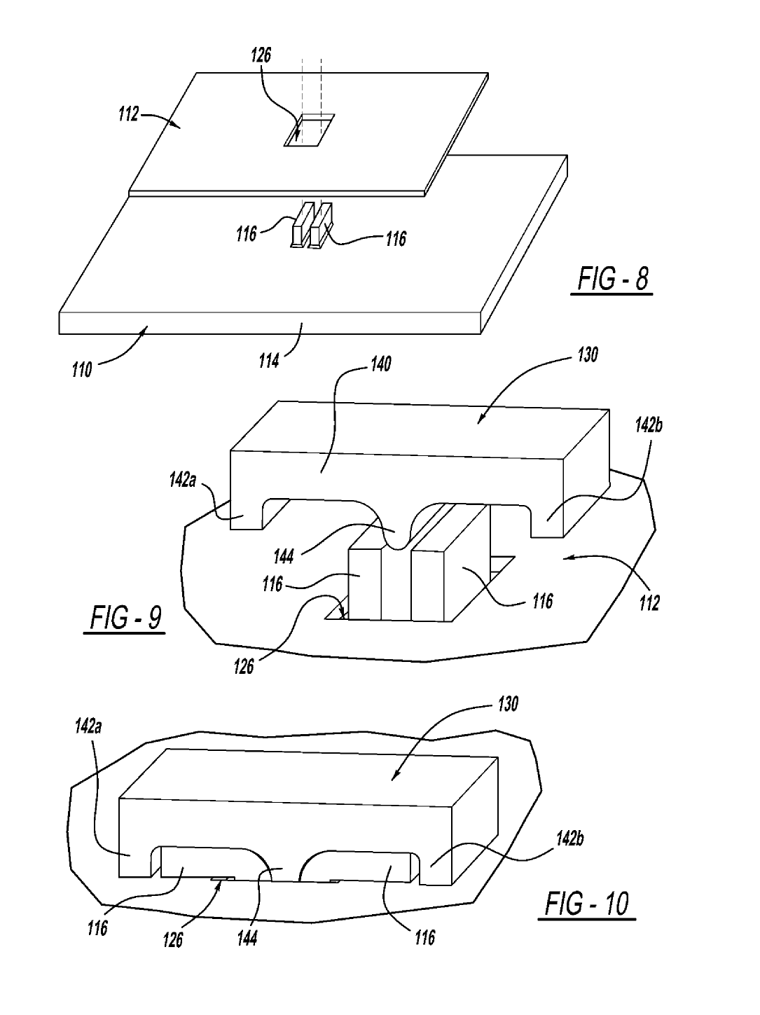

The joining of other first and second parts 110, 112 according to additional embodiments will now be discussed in reference to FIGS. 8-11. As shown, the first part 110 can include a base 114 and a plurality of protrusions 116, and each protrusion 116 can be rib-shaped. For instance, each protrusion 116 can be a block with a plurality of substantially flat sides (e.g., the cross section of each protrusion 116 can be rectangular or otherwise polygonal). Similar to the embodiments discussed above, the first part 110 can be cast metallic material to include both the base 114 and the protrusions 116.

The second part 112 can be substantially similar to the embodiments discussed above. However, the opening 126 can be a rectangular through-hole. As shown in FIG. 9, the opening 126 can simultaneously receive both the protrusions 116.

Moreover, as shown in FIGS. 9 and 10, the tool 130 can be M-shaped so as to include a base 140, a first and second stop 142a, 142b extending from opposite ends of the base 140, and a die 144 extending from the base 140 between the stops 142a, 142b.

In certain embodiments, the configuration (e.g., the shape, thickness, materials, etc.) of the parts 110, 112 (and/or the configuration of the protrusion 116) can be tailored so that the protrusion 116 deforms more easily or quicker without undesirable fracture. Also, in some embodiments, the deformed protrusion 116 is of a desirable configuration to provide joint strength in predetermined orientations or load vectors to suit predicted load conditions and/or to provide joined-part assembly flexibility or rigidity in a predetermined orientation to suit a certain application.

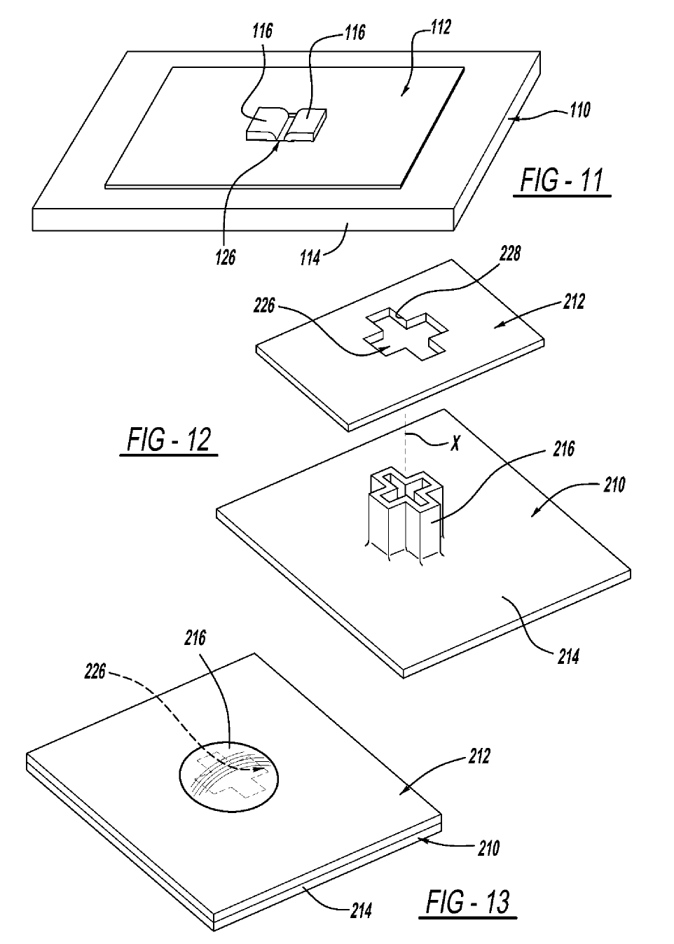

The tool 130 can move axially toward the protrusions 116 such that the die 144 is received between the protrusions 116 as shown in FIG. 9. Further movement of the tool 130 can push and deform the protrusions 116 away from each other and toward the respective stops 142a, 142b. Thus, the protrusions 116 can bend over the second part 112 as shown in FIGS. 10 and 11. The protrusions 116 can bend enough to abut the second part 112 and retain the second part 112 between the protrusions 116 and the base 114 of the first part 110. It will be appreciated that the tool 130 can also apply heat to the protrusions 116, and/or the tool 130 can apply friction to the protrusions 116 in order to facilitate the deformation of the protrusions 116.

Additional embodiments are illustrated in FIGS. 12 and 13 and will now be discussed. As shown, the first part 210 can include a base 214 and a protrusion 216. The protrusion 216 can be substantially cruciform in cross section. Similar to the embodiments discussed above, the first part 210 can be cast out of a metallic material to include both the base 114 and the protrusions 116. The protrusion 216 can also be hollow, similar to the embodiments shown in FIGS. 1-7.

The second part 212 can be substantially similar to the embodiments discussed above. However, the opening 226 can be substantially cruciform in shape so as to correspond to and receive the protrusion 216. As shown in FIG. 13, the protrusion 216 can be deformed (by pressure, friction, heat, etc.) over the second part 212 to operably couple the first and second parts 210, 212 together.

It will be appreciated that the first and second parts 210, 212 can be limited against relative rotation about the axis X. For instance, when the second part 212 is mated to the first part 210 and the opening 226 receives the protrusion 216 (but before the protrusion 216 is deformed), the flat sides of the protrusion 216 can abut against the flat inner surface 228 of the opening 226 to limit relative rotation of the first and second parts 210, 212. Thus, assembly of the first and second parts 210, 212 can be further facilitated because there can be only one relative orientation of the first and second parts 210, 212. It will be appreciated that the protrusion 216 and the opening 226 can be shaped in any various ways such that there is only one relative orientation of the first and second parts 210, 212.

In summary, the assembly of the first and second parts 10, 12, 110, 112, 210, 212 according to the present teachings can greatly facilitate the assembly of various components. These methods can be employed in high-volume production rates. Also, the parts 10, 12, 110, 112, 210, 212 can be of dissimilar materials, and this can allow for significant weight savings and other advantages.

Furthermore, in some embodiments, the joined-part assembly can include more than two parts. For example, a third part can be positioned between and abut the first and second parts 10, 12, 110, 112, 210, 212, and the third part can include an aperture configured to receive the protrusion 16, 116, 216 therethrough. In still other embodiments, the second part 12, 112, 212, such as those described above, can include a protrusion configured to be inserted through an aperture of a third part to be disposed over the second part wherein the protrusion protruding through the aperture of the third part is then deformed to retain the third part to the second part.

Moreover, porous and low-ductility metals can be joined in this manner. No separate fasteners or consumables need be employed in joining the parts 10, 12, 110, 112, 210, 212, and as such, the parts 10, 12, 110, 112, 210, 212 can be joined in a less labor-intensive manner. There can also be less of a risk of galvanic corrosion as compared, for instance, to joining methods using steel fasteners in aluminum or magnesium parts. Moreover, no special pre-treatments are necessary as compared, for instance, to adhesive bonding methods.

What is claimed is:

1. A method of coupling a plurality of parts together comprising:
casting a first part to include a base and a protrusion that protrudes from the base, the first part made from a metallic material;
providing a second part with an opening;
mating the first and second parts such that the protrusion is received within the opening; and
deforming the protrusion over the second part such that the second part is retained between the deformed protrusion and the base of the first part.

2. The method of claim 1, wherein the metallic material of the first part includes at least one of magnesium or a magnesium alloy.

3. The method of claim 1, wherein the second part is made from a material different from the metallic material of the first part.

4. The method of claim 1, wherein the opening is a through-hole.

5. The method of claim 1, wherein deforming the protrusion includes applying a force substantially parallel to an axis of the protrusion.

6. The method of claim 1, wherein deforming the protrusion includes rotating a tool against the protrusion to create friction between the tool and the protrusion.

7. The method of claim 1, wherein deforming the protrusion includes applying heat to the protrusion.

8. The method of claim 1, wherein casting the first part to include the protrusion includes casting the first part to include a substantially cylindrical protrusion.

9. The method of claim 1, wherein casting the first part to include the protrusion includes casting the first part to include a protrusion with a cross section taken perpendicular to an axis of the protrusion, the cross section having a substantially flat side.

10. The method of claim 9, wherein mating the first and second parts includes limiting relative rotation between the first and second parts by abutting the flat side of the protrusion against a flat side of the opening of the second part.

11. The method of claim 10, wherein casting the first part to include the protrusion includes casting the first part to include a protrusion with a substantially cruciform cross sectional shape, and wherein providing the second part includes providing the second part with a substantially cruciform opening.

12. The method of claim 1, further comprising providing a third part between the first part and the second part.

13. The method of claim 1, wherein deforming the protrusion includes deforming the protrusion radially away from an axis of the protrusion.

14. An assembly comprising:
a first part that is made from cast metallic material, the first part including a base and a protrusion; and
a second part with an opening that receives the protrusion, the protrusion deformed such that the second part is retained between the deformed protrusion and the base of the first part.

15. The assembly of claim 14, wherein the second part is made from a material different from the metallic material of the first part.

16. The assembly of claim 14, wherein the opening is a through-hole.

17. The assembly of claim 14, wherein the protrusion is at least partially cylindrical.

18. The assembly of claim 14, wherein the protrusion is bent over the second part.

19. The assembly of claim 14, wherein the first and second parts are limited against rotation relative to each other due to mating of the protrusion and the opening.

20. The assembly of claim 14, further comprising a third part that abuts against the second part.
